(19) United States
(12) Patent Application Publication
(10) Pub. No.: US 2025/0097685 A1
(43) Pub. Date: Mar. 20, 2025

(54) METHODS AND SYSTEMS FOR DISCOVERING NODES AND/OR DEVICES OF A BUILDING CONTROL SYSTEM USING A SPARKPLUG PROTOCOL

(71) Applicant: Honeywell International Inc., Charlotte, NC (US)

(72) Inventors: Chen Shanshan, Tianjin (CN); Lifen Zhang, Beijing (CN); Shao Min Sun, Beijing (CN); Shida Wang, Tianjin (CN); Will Qi, Beijing (CN); Yingying Zhu, Beijing (CN)

(21) Appl. No.: 18/821,742

(22) Filed: Aug. 30, 2024

(30) Foreign Application Priority Data
Sep. 19, 2023 (WO) PCT/CN2023/119621

(51) Int. Cl. H04W 8/00; G05B 15/02; G06F 3/04842

(52) U.S. Cl. CPC H04W 8/005; G05B 15/02; G06F 3/04842; G05B 2219/2642

(57) ABSTRACT

A discover method includes a collection phase and a subsequent discovery phase. The collection phase includes receiving an NBIRTH message for each node and receiving a DBIRTH message for each device. A group ID and a corresponding node ID are extracted and cached from each NBIRTH message and a group ID, a node ID and a device ID are extracted from each DBIRTH message. The discovery phase includes publishing a REBIRTH message for each node having a cached group ID and node ID. The REBIRTH message causes the corresponding node to publish an NBIRTH message for the corresponding node, as well as a DBIRTH message for each associated device. Nodes may be discovered based on the NBIRTH messages published during the discovery phase and devices may be discovered based on the DBIRTH messages published during the discovery phase.

The present application claims priority to PCT International Application No. PCT/CN2023/119621, filed on Sep. 19, 2023, entitled “METHODS AND SYSTEMS FOR DISCOVERING NODES AND/OR DEVICES OF A BUILDING CONTROL SYSTEM USING A SPARKPLUG PROTOCOL”, which is incorporated herein by reference.

### TECHNICAL FIELD

The present disclosure relates generally to methods for discovering nodes and/or devices of a building control system and more particularly to methods for discovering nodes and/or devices of a building control system using a sparkplug protocol.

### BACKGROUND

Building control systems such as security systems, fire safety systems and HVAC (Heating, Ventilating and Air Conditioning) systems may include a large number of individual building control devices and/or corresponding nodes. Because there may be a large number of devices and/or nodes, discovering devices and/or nodes of the building control system may be time consuming and tedious. Some building control systems employ a message broker for communicating between devices and/or nodes. The message broker may use a defined message broker communication protocol such as the Sparkplug protocol. The defined message broker communication protocol may not provide discovery commands for use in performing on-demand discovery of devices and/or nodes. What would be desirable are methods and systems for discovering devices and/or nodes within a building control system that employs a message broker communication protocol such as the Sparkplug protocol.

### SUMMARY

The present disclosure relates generally to methods and systems for discovering nodes and/or devices of a building control system and more particularly to methods and systems for discovering nodes and/or devices of a building control system using a message broker communication protocol such as the Sparkplug protocol. An example may be found in a method for discovering one or more nodes and one or more devices associated with the one or more nodes of a building control system using a sparkplug protocol. The illustrative method includes a collection phase, and a discovery phase that follows the collection phase. The collection phase includes receiving an NBIRTH message for each of one or more nodes of the building control system and receiving a DBIRTH message for each of one or more devices of the building control system. A group ID and a corresponding node ID are extracted from the NBIRTH message for each of the one or more nodes and a group ID, a node ID and a device ID are extracted from the DBIRTH message for each of one or more devices. The extracted group ID and node ID are cached for each of the one or more nodes that are identified by the NBIRTH and DBIRTH messages. The discovery phase includes publishing a REBIRTH message for each of one or more of the nodes that have a cached group ID and node ID combination, where the REBIRTH message causes the corresponding node to publish an NBIRTH message for the corresponding node, and in some cases, to publish a DBIRTH message for each of one or more devices that are associated with the corresponding node. The discovery phase includes discovering one or more nodes of the building control system based on the NBIRTH messages published during the discovery phase and discovering one or more devices of the building control system based on the DBIRTH messages published during the discovery phase.

Another example may be found in a non-transitory computer readable medium storing instructions that when executed by one or more processors cause the one or more processors to accept user input to enter a collection phase. Once in the collection phase, the one or more processors are caused to receive an NBIRTH message for each of one or more nodes of a building control system and to receive a DBIRTH message for each of one or more devices of the building control system. The one or more processors are caused to extract from the NBIRTH messages a group ID and a corresponding node ID for each of the one or more nodes and to extract from the DBIRTH messages, a group ID, a node ID and a device ID for each of one or more devices. The one or more processors are caused to cache the extracted group ID and node ID for each of the one or more nodes. The one or more processors are caused to accept user input to enter a discovery phase. Once in the discovery phase, the one or more processors are caused to publish a REBIRTH message for each of one or more of the nodes that have a cached group ID and node ID combination, where the REBIRTH message causes the corresponding node to publish an NBIRTH message for the corresponding node and to publish a DBIRTH message for each of one or more devices that are associated with the corresponding node. The one or more processors are caused to discover one or more nodes of the building control system based on the NBIRTH messages published during the discovery phase and to discover one or more devices of the building control system based on the DBIRTH messages published during the discovery phase.

Another example may be found in a method for discovering one or more nodes of a building control system using a sparkplug protocol. The method includes receiving messages from an MQTT broker and extracting a group ID and a node ID from each message, wherein the extracted group ID and node ID identify a particular node of the building control system. The method includes determining whether the extracted group ID and node ID for each message corresponds to an undiscovered node of the building control system. For those messages where the extracted group ID and node ID correspond to an undiscovered node, a REBIRTH message is generated and published to the corresponding undiscovered node using the extracted group ID and node ID, where the REBIRTH message causes the corresponding undiscovered node to publish a corresponding NBIRTH message. The corresponding undiscovered node of the building control system are discovered based on the NBIRTH messages published by the corresponding undiscovered node.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing an illustrative building control system having nodes and associated devices;

FIGS. 2A, 2B, 2C and 2D are flow diagrams that together show an illustrative method for discovering one or more nodes and one or more associated devices of a building control system using a Sparkplug protocol;

FIGS. 3A and 3B are flow diagrams that together show an illustrative method for discovering one or more nodes of a building control system using a Sparkplug protocol; and

FIG. 4 is a flow diagram showing an illustrative method.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic is described in connection with an embodiment, it is contemplated that the feature, structure, or characteristic may be applied to other embodiments whether or not explicitly described unless clearly stated to the contrary.

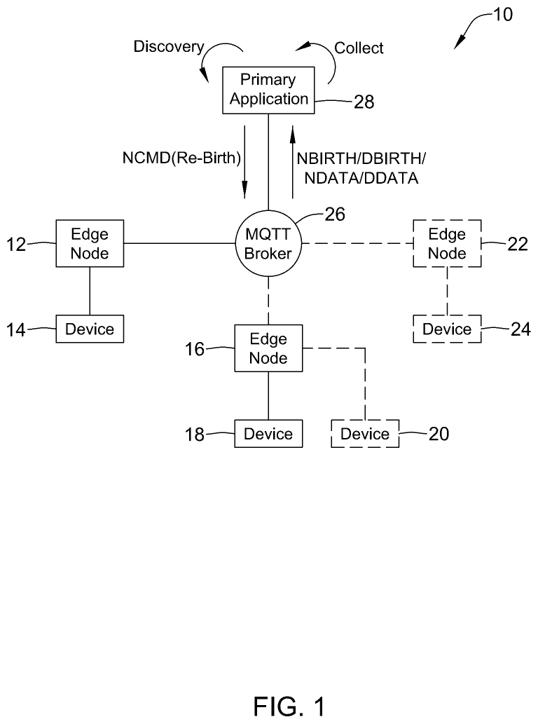

FIG. 1 is a schematic block diagram showing an illustrative building control system 10. The illustrative building control system 10 includes an edge node 12 that is associated with a device 14, an edge node 16 that is associated with a device 18 and with a device 20 and an edge node 22 that is associated with a device 24. In some instances, the edge nodes 12, 16 and 22 are logical devices that are associated with corresponding physical devices 14, 18, 20 and 24, for example. In some instances, the edge nodes 12, 16 and 22 are physical devices that are connected to physical devices 14, 18, 20 and 24, for example. Each of the edge nodes 12, 16 and 22 may be in communication with an MQTT broker 26. In some instances, generally speaking, the MQTT broker 26 may be configured to receive messages from publishers and to provide messages to subscribers. In some instances, the MQTT broker 26 serves to regulate communication between the edge nodes 12, 16 and 22 and a primary application 28. The edge nodes 12, 16 and 22 may be considered as being publishers while the primary application 28 may be considered as being a subscriber. In some instances, the edge nodes 12, 16 and 22 may be considered as being subscribers while the primary application 28 may be considered as a publisher, depending on the direction of the communication. In some instances, NBIRTH messages, DBIRTH messages, NDATA messages and DDATA messages may flow from the MQTT broker 26 to the primary application 28 and NCMD (e.g. rebirth) messages may flow from the primary application 28 to the MQTT broker 26.

In some instances, some of the edge nodes, such as the edge node 12 and the edge node 16, may be considered as being known to the MQTT broker 26 and to the primary application 28 as a result of having previously been discovered. Similarly, some of the devices, such as the device 14 associated with the edge node 12, and the device 18 associated with the edge node 16 may be considered as being known to the MQTT broker 26 and to the primary application 28 as a result of having previously been discovered. Some edge nodes, such as the edge node 22, may be considered as being newly discovered. Similarly, some devices, such as the device 20, newly associated with the edge node 16, and the device 24, associated with the edge node 22, may be considered as being newly discovered in this example.

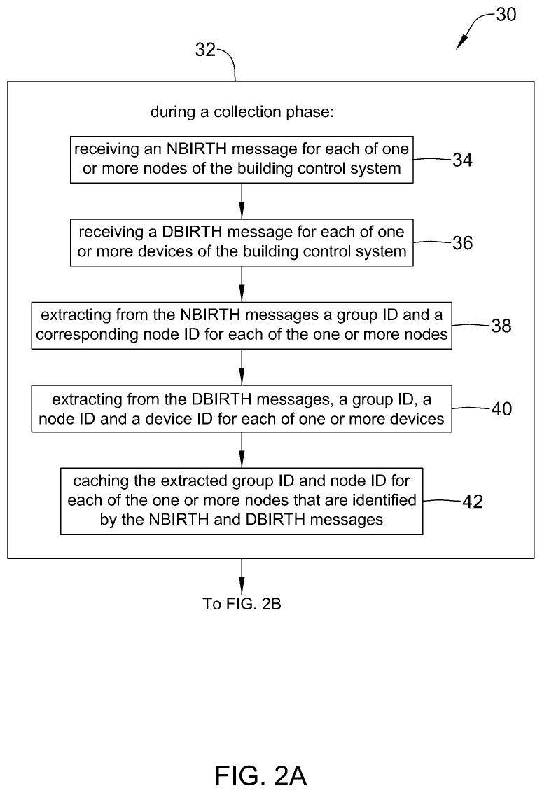

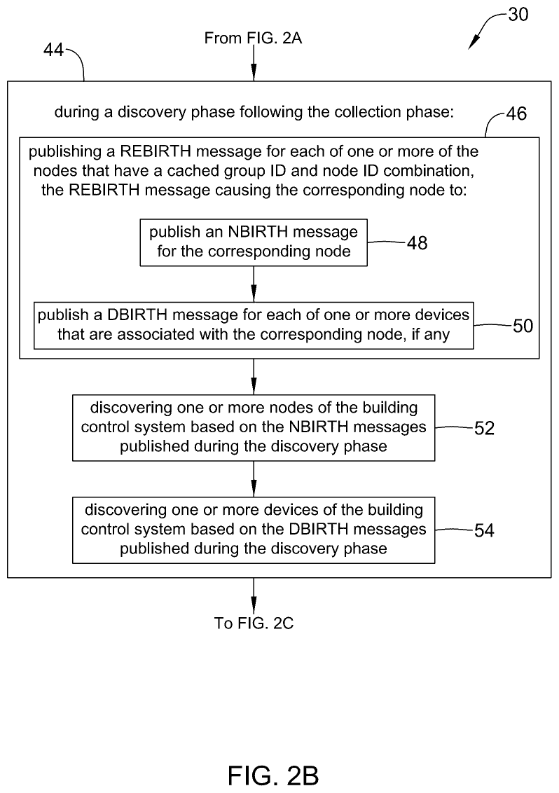

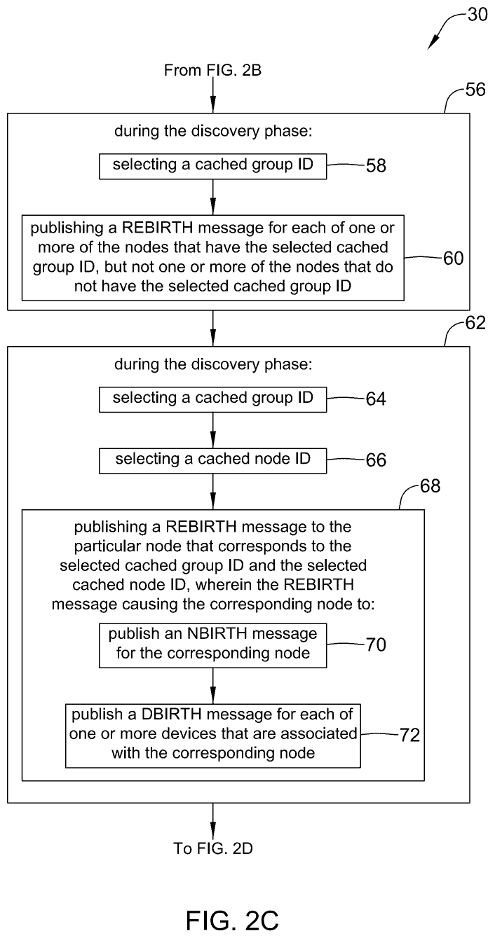

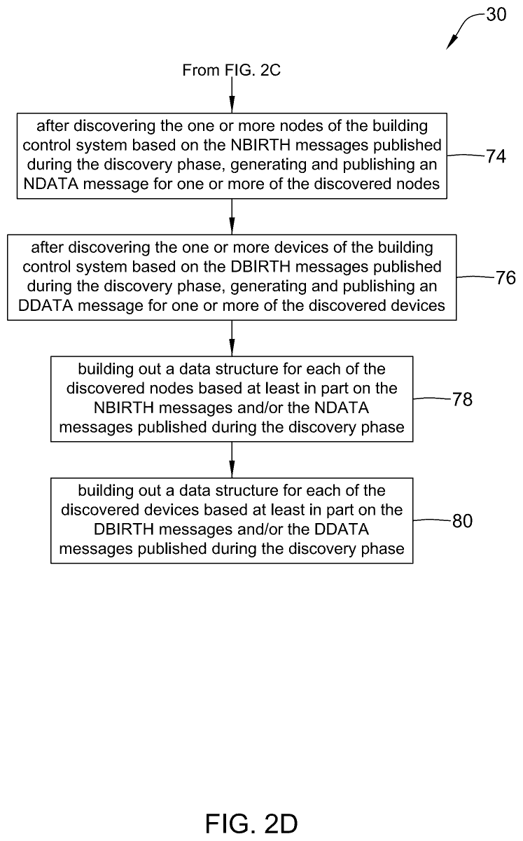

FIGS. 2A, 2B, 2C and 2D are flow diagrams that together show an illustrative method 30 for discovering one or more nodes and one or more associated devices of a building control system (such as the building control system 10) using the Sparkplug protocol. The illustrative method 30 includes a collection phase and a discovery phase. In some instances, a user may provide user input to enter the collection phase and/or to enter the discovery phase. During the collection phase, the illustrative method 30 includes a series of steps as indicated at block 32. The series of steps includes receiving an NBIRTH message for each of one or more nodes of the building control system, as indicated at block 34. A DBIRTH message is received for each of one or more devices of the building control system, as indicated at block 36. The illustrative method 30 includes extracting from the NBIRTH messages a group ID and a corresponding node ID for each of the one or more nodes, as indicated at block 38. The illustrative method 30 includes extracting from the DBIRTH messages, a group ID, a node ID and a device ID for each of one or more devices, as indicated at block 40. The extracted group ID and node ID are cached for each of the one or more nodes that are identified by the NBIRTH and DBIRTH messages, as indicated at block 42. In some instances, this may include determining when a group ID and node ID combination has already been extracted, and when so determined, only caching the extracted group ID and node ID once for the particular node to avoid duplicates.

The method 30 continues on FIG. 2B with the discovery phase, as indicated at block 44. The discovery phase includes publishing a REBIRTH message for each of one or more of the nodes that have a cached group ID and node ID combination, as indicated at block 48. The REBIRTH message causes the corresponding node to publish an NBIRTH message for the corresponding node, as indicated at block 48. The REBIRTH message may also cause the corresponding node to publish a DBIRTH message for each of one or more devices that are associated with (e.g. connected to) the corresponding node, if any, as indicated at block 50. The illustrative method 30 includes discovering one or more nodes of the building control system based on the NBIRTH messages published during the discovery phase, as indicated at block 52. The method 30 includes discovering one or more devices of the building control system based on the DBIRTH messages published during the discovery phase, as indicated at block 54. In some instances, the NBIRTH and DBIRTH messages may be received by an application program that is operatively coupled to each of the one or more nodes via an MQTT broker, and wherein the application program is placed in a collection mode by a user during the collection phase and in a discovery mode during the discovery phase. In some instances, each of the one or more nodes may be configured to automatically publish a corresponding NBIRTH message when the corresponding node initially comes on-line with the MQTT broker.

The illustrative method 30 continues on FIG. 2C with additional steps that may be carried out during the discovery phase, as indicated at block 56. In some instances, the method 30 may further include selecting a cached group ID, as indicated at block 58. As an example, the selected cached group ID may be selected by a user via a user interface. The method 30 may further include publishing a REBIRTH message for each of one or more of the nodes that have the selected cached group ID, but not one or more of the nodes that do not have the selected cached group ID, as indicated at block 60. In some instances, the REBIRTH message may be published in response to receiving a discovery request from the user.

In some instances, the illustrative method 30 may include additional steps that may be carried out during the discovery phase, as indicated at block 62. The method 30 may further include selecting a cached group ID, as indicated at block 64, and selecting a cached node ID, as indicated at block 66. The method 30 may include publishing a REBIRTH message to the particular node that corresponds to the selected cached group ID and the selected cached node ID, as indicated at block 68. The REBIRTH message may cause the corresponding node to publish an NBIRTH message for the corresponding node, as indicated at block 70. The REBIRTH message may also cause the corresponding node to publish a DBIRTH message for each of one or more devices that are associated with (e.g. connected to) the corresponding node, if any, as indicated at block 72.

The illustrative method 30 continues on FIG. 2D, where after discovering the one or more nodes of the building control system based on the NBIRTH messages published during the discovery phase, an NDATA message is generated and published for one or more of the discovered nodes, as indicated at block 74. After discovering the one or more devices of the building control system based on the DBIRTH messages published during the discovery phase, an DDATA message is generated and published for one or more of the discovered devices, as indicated at block 76. In some instances, a data structure is built out for each of the discovered nodes based at least in part on the NBIRTH messages and/or the NDATA messages published during the discovery phase, as indicated at block 78. In some instances, a data structure is built out for each of the discovered devices based at least in part on the DBIRTH messages and/or the DDATA messages published during the discovery phase, as indicated at block 80.

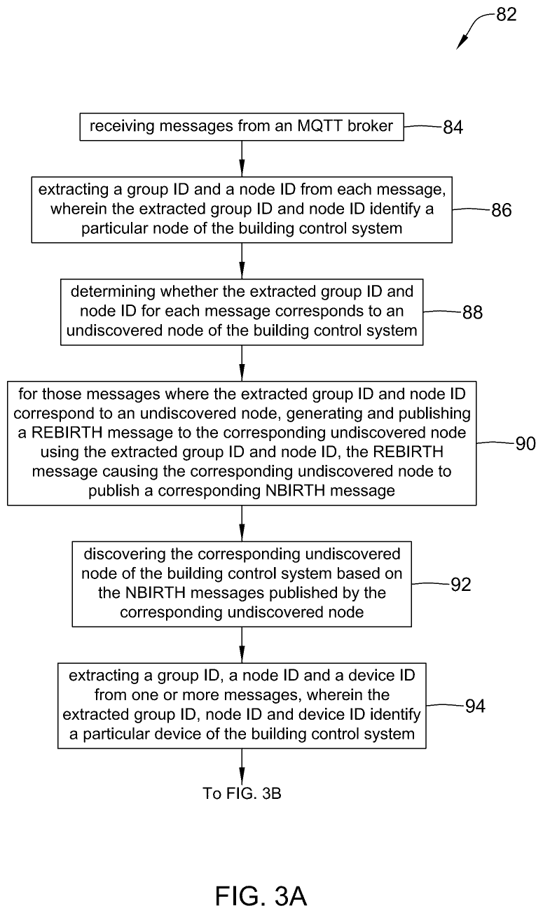

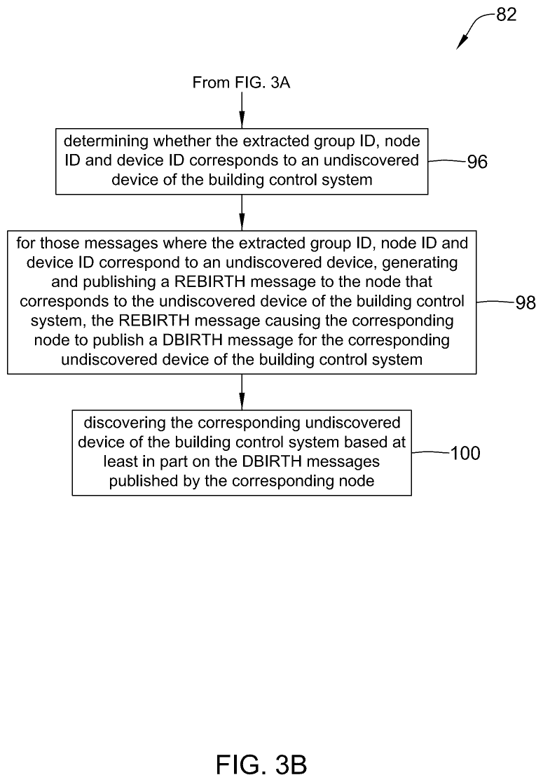

FIGS. 3A, 3B, 3C and 3D are flow diagrams that together show an illustrative method 82 for discovering one or more nodes and one or more associated devices of a building control system (such as the building control system 10) using the Sparkplug protocol. The method 82 includes receiving messages from an MQTT broker, as indicated at block 84. A group ID and a node ID is extracted from each message, wherein the extracted group ID and node ID identify a particular node of the building control system, as indicated at block 86. A determination is made as to whether the extracted group ID and node ID for each message corresponds to an undiscovered node of the building control system, as indicated at block 88. For those messages where the extracted group ID and node ID correspond to an undiscovered node, a REBIRTH message is generated and published to the corresponding undiscovered node using the extracted group ID and node ID, where the REBIRTH message causes the corresponding undiscovered node to publish a corresponding NBIRTH message, as indicated at block 90. The corresponding undiscovered node of the building control system are discovered based on the NBIRTH messages published by the corresponding undiscovered node, as indicated at block 92. In some instances, the method 82 may include extracting a group ID, a node ID and a device ID from one or more messages, wherein the extracted group ID, node ID and device ID identify a particular device of the building control system, as indicated at block 94.

The method 82 continues on FIG. 3B with determining whether the extracted group ID, node ID and device ID corresponds to an undiscovered device of the building control system, as indicated at block 96. For those messages where the extracted group ID, node ID and device ID correspond to an undiscovered device, a REBIRTH message is generated and published to the node that corresponds to the undiscovered device of the building control system, where the REBIRTH message causes the corresponding node to publish a DBIRTH message for the corresponding undiscovered device of the building control system, as indicated at block 98. The corresponding undiscovered device of the building control system are discovered based at least in part on the DBIRTH messages published by the corresponding node, as indicated at block 100.

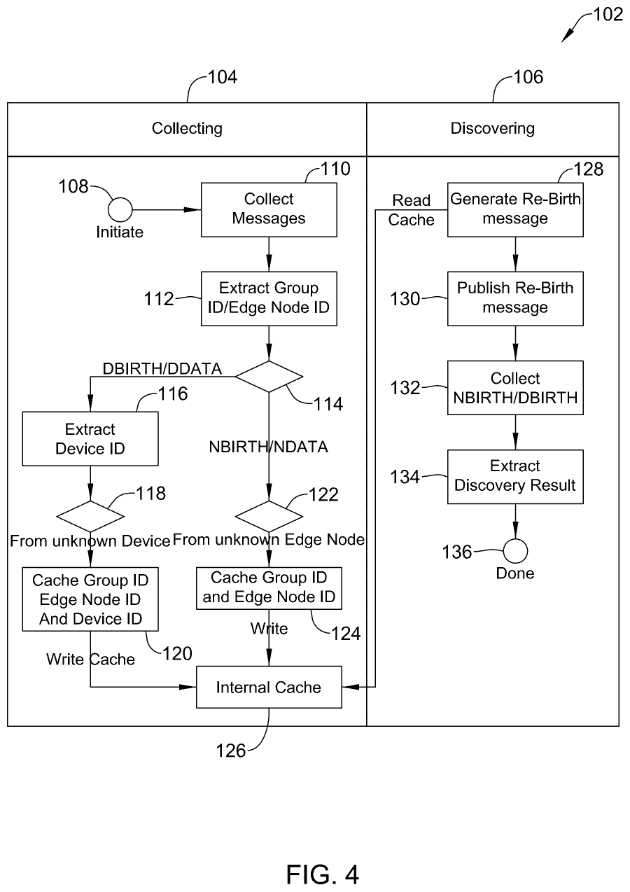

FIG. 4 is a flow diagram showing an illustrative method 102. The illustrative method 102 may be considered as including a collecting phase 104 and a discovering phase 106. The illustrative method 102 begins in the collecting phase 104, at an initiate block 108. Messages are collected, as indicated at block 110. Group ID and Edge Node ID information are extracted, as indicated at block 112. A determination is made as to whether the extracted information pertain to a device or an edge node, as indicated at decision block 114. If the extracted information pertains to a device, control passes to block 116, where the Device ID is extracted. At decision block 118, a determination is made as to whether the Device ID represents an unknown device (e.g. not yet discovered). If so, control passes to block 120 and the Group ID, Edge Node ID and Device ID associated with the device are cached to an internal cache 126. If at decision block 114 the extracted information pertains to an edge node, control passes to decision block 122, where a determination is made as to whether the edge node is unknown. If the edge node is unknown (e.g. not yet discovered), the Group ID and Edge Node ID are cached to the internal cache 126.

In the discovering phase 106, the illustrative method 102 includes generating a Re-Birth message, as indicated at block 128. The Re-Birth message may be based upon information read from the internal cache 126, for example. A Re-Birth message is published, as indicated at block 130. In response to the Re-Birth message, NBIRTH and DBIRTH messages are published, and information from the NBIRTH and DBIRTH messages is collected, as indicated at block 132. Discovery results may be extracted from the NBIRTH and DBIRTH information, as indicated at block 134. The discovering phase 106 terminates at a DONE block 136.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for discovering one or more nodes and one or more devices associated with the one or more nodes of a building control system using a sparkplug protocol, the method comprising:
during a collection phase:
receiving an NBIRTH message for each of one or more nodes of the building control system;
receiving a DBIRTH message for each of one or more devices of the building control system;
extracting from the NBIRTH messages a group ID and a corresponding node ID for each of the one or more nodes;
extracting from the DBIRTH messages, a group ID, a node ID and a device ID for each of one or more devices;
caching the extracted group ID and node ID for each of the one or more nodes that are identified by the NBIRTH and DBIRTH messages;
during a discovery phase following the collection phase:
publishing a REBIRTH message for each of one or more of the nodes that have a cached group ID and node ID combination, the REBIRTH message causing the corresponding node to:
publish an NBIRTH message for the corresponding node;
publish a DBIRTH message for each of one or more devices that are associated with the corresponding node, if any;
discovering one or more nodes of the building control system based on the NBIRTH messages published during the discovery phase; and
discovering one or more devices of the building control system based on the DBIRTH messages published during the discovery phase.

2. The method of claim 1, wherein during the discovery phase:
selecting a cached group ID; and
publishing a REBIRTH message for each of one or more of the nodes that have the selected cached group ID, but not one or more of the nodes that do not have the selected cached group ID.

3. The method of claim 2, wherein the selected cached group ID is selected by a user via user interface.

4. The method of claim 3, wherein the REBIRTH message is published in response to receiving a discovery request from the user.

5. The method of claim 1, wherein during the discovery phase:
selecting a cached group ID;
selecting a cached node ID;
publishing a REBIRTH message to the particular node that corresponds to the selected cached group ID and the selected cached node ID, wherein the REBIRTH message causing the corresponding node to:
publish an NBIRTH message for the corresponding node; and
publish a DBIRTH message for each of one or more devices that are associated with the corresponding node, if any.

6. The method of claim 1, wherein during the collection phase:
determining when a group ID and node ID combination has already been extracted, and when so determined, only caching the extracted group ID and node ID once for the particular node.

7. The method of claim 1, wherein the NBIRTH and DBIRTH messages are received by an application program that is operatively coupled to each of the one or more nodes via an MQTT broker, and wherein the application program is placed in a collection mode by a user during the collection phase and in a discovery mode during the discovery phase.

8. The method of claim 7, wherein each of the one or more nodes is configured to automatically publish a corresponding NBIRTH message when the corresponding node initially comes on-line with the MQTT broker.

9. The method of claim 1, comprising:
after discovering the one or more nodes of the building control system based on the NBIRTH messages published during the discovery phase, generating and publishing an NDATA message for one or more of the discovered nodes; and
after discovering the one or more devices of the building control system based on the DBIRTH messages published during the discovery phase, generating and publishing an DDATA message for one or more of the discovered devices.

10. The method of claim 9, comprising:
building out a data structure for each of the discovered nodes based at least in part on the NBIRTH messages and/or the NDATA messages published during the discovery phase.

11. The method of claim 9, comprising:
building out a data structure for each of the discovered devices based at least in part on the DBIRTH messages and/or the DDATA messages published during the discovery phase.

12. A non-transitory computer readable medium storing instructions that when executed by one or more processors cause the one or more processors to:
accept user input to enter a collection phase, and once in the collection phase:
receive an NBIRTH message for each of one or more nodes of a building control system;
receive a DBIRTH message for each of one or more devices of the building control system;
extract from the NBIRTH messages a group ID and a corresponding node ID for each of the one or more nodes;
extract from the DBIRTH messages, a group ID, a node ID and a device ID for each of one or more devices;
cache the extracted group ID and node ID for each of the one or more nodes;
accept user input to enter a discovery phase, and once in the discovery phase:
publish a REBIRTH message for each of one or more of the nodes that have a cached group ID and node ID combination, the REBIRTH message causing the corresponding node to:
publish an NBIRTH message for the corresponding node;
publish a DBIRTH message for each of one or more devices that are associated with the corresponding node, if any;
discover one or more nodes of the building control system based on the NBIRTH messages published during the discovery phase; and
discover one or more devices of the building control system based on the DBIRTH messages published during the discovery phase.

13. The non-transitory computer readable medium of claim 12, wherein during the discovery phase, the instructions cause the one or more processors to:
accept a selection from a user of a particular cached group ID; and
publish a REBIRTH message for each of one or more of the nodes that have the selected cached group ID, but not one or more of the nodes that do not have the selected cached group ID.

14. The non-transitory computer readable medium of claim 12, wherein during the discovery phase, the instructions cause the one or more processors to:
accept a selection from a user of a selected cached group ID;
accept a selection from the user of a selected cached node ID;
publish a REBIRTH message to the particular node that corresponds to the selected cached group ID and the selected cached node ID, wherein the REBIRTH message causing the corresponding node to:
publish an NBIRTH message for the corresponding node; and
publish a DBIRTH message for each of one or more devices that are associated with the corresponding node, if any.

15. The non-transitory computer readable medium of claim 12, wherein during the collection phase, the instructions cause the one or more processors to:
determine when a group ID and node ID combination has already been extracted, and when so determined, only caching the extracted group ID and node ID once for the particular node.

16. The non-transitory computer readable medium of claim 12, wherein the instructions cause the one or more processors to execute an application program, wherein the NBIRTH and DBIRTH messages are received by the application program, and the application program is placed into a collection mode by a user input during the collection phase and into a discovery mode during the discovery phase.

17. The non-transitory computer readable medium of claim 12, wherein the instructions cause the one or more processors to:
after discovering the one or more nodes of the building control system based on the NBIRTH messages published during the discovery phase, generate and publish an NDATA message for one or more of the discovered nodes; and
after discovering the one or more devices of the building control system based on the DBIRTH messages published during the discovery phase, generate and publish a DDATA message for one or more of the discovered devices.

18. The non-transitory computer readable medium of claim 12, wherein the instructions cause the one or more processors to:
build out a data structure for each of the discovered nodes based at least in part on the NBIRTH messages and/or the NDATA messages published during the discovery phase; and
build out a data structure for each of the discovered devices based at least in part on the DBIRTH messages and/or the DDATA messages published during the discovery phase.

19. A method for discovering one or more nodes of a building control system using a sparkplug protocol, the method comprising:
receiving messages from an MQTT broker;
extracting a group ID and a node ID from each message, wherein the extracted group ID and node ID identify a particular node of the building control system;
determining whether the extracted group ID and node ID for each message corresponds to an undiscovered node of the building control system;
for those messages where the extracted group ID and node ID correspond to an undiscovered node, generating and publishing a REBIRTH message to the corresponding undiscovered node using the extracted group ID and node ID, the REBIRTH message causing the corresponding undiscovered node to publish a corresponding NBIRTH message; and
discovering the corresponding undiscovered node of the building control system based on the NBIRTH messages published by the corresponding undiscovered node.

20. The method of claim 19, comprising:
extracting a group ID, a node ID and a device ID from one or more messages, wherein the extracted group ID, node ID and device ID identify a particular device of the building control system;
determining whether the extracted group ID, node ID and device ID corresponds to an undiscovered device of the building control system;
for those messages where the extracted group ID, node ID and device ID correspond to an undiscovered device, generating and publishing a REBIRTH message to the node that corresponds to the undiscovered device of the building control system, the REBIRTH message causing the corresponding node to publish a DBIRTH message for the corresponding undiscovered device of the building control system; and
discovering the corresponding undiscovered device of the building control system based at least in part on the DBIRTH messages published by the corresponding node.
